(19) United States
(12) Patent Application Publication
(10) Pub. No.: US 2023/0195818 A1
(43) Pub. Date: Jun. 22, 2023

(54) SEARCH TRIGGERING METHOD AND APPARATUS, ELECTRONIC DEVICE AND STORAGE MEDIUM

(71) Applicant: Beijing Bytedance Network Technology Co., Ltd., Beijing (CN)

(72) Inventor: Shuohong ZHU, Beijing (CN)

(21) Appl. No.: 17/998,874

(22) PCT Filed: May 13, 2021
(86) PCT No.: PCT/CN2021/093569

§ 371 Date: Nov. 15, 2022

(30) Foreign Application Priority Data
May 26, 2020 (CN) 202010455006.3

(51) Int. Cl. G06F 16/954

(52) U.S. Cl. CPC G06F 16/954

(57) ABSTRACT

A method and an apparatus for triggering a search, an electronic device and a storage medium are provided. The method includes: acquiring description content in multimedia content; selecting, from candidate keywords corresponding to the description content, a target keyword matching an entity word in an entity library; generating, based on a search result under at least one content type corresponding to the target keyword, search result aggregation information corresponding to the target keyword; and adding a search identifier to the target keyword in the description content, where the search identifier points to the search result aggregation information corresponding to the target keyword.

### CROSS REFERENCE OF RELATED APPLICATION

The present application claims priority to Chinese Patent Application No. 202010455006.3, titled “SEARCH TRIGGERING METHOD AND APPARATUS, ELECTRONIC DEVICE AND STORAGE MEDIUM”, filed on May 26, 2020 with the China National Intellectual Property Administration, which is incorporated herein by reference in its entirety.

### FIELD

The present disclosure relates to the technical field of computers, and in particular to a method and an apparatus for triggering a search, an electronic device and a storage medium.

### BACKGROUND

With the continuous development of computer technologies, the application of the Internet has become increasingly popular. Internet users may obtain network resources via search engines as required. A user, when browsing network resources, usually initiates a search via search engines, to obtain other unknown information in the network resources.

Generally, a user has to manually input a keyword to initiate a search request for unknown information, which results in a long path to a search result and thus is time-consuming.

### SUMMARY

At least one solution for triggering a search is provided according to embodiments of the present disclosure. A search is automatically initiated by triggering a target keyword with a search identifier without manual input, thereby reducing the time spent on searching and improving search experience of users.

The solution according to embodiments of the present disclosure includes the following aspects.

In a first aspect, a method for triggering a search is provided according to an embodiment of the present disclosure. The method includes: acquiring description content in multimedia content; selecting, from candidate keywords corresponding to the description content, a target keyword matching an entity word in an entity library; generating, based on a search result under at least one content type corresponding to the target keyword, search result aggregation information corresponding to the target keyword; and adding a search identifier to the target keyword in the description content, where the search identifier points to the search result aggregation information corresponding to the target keyword.

In an embodiment, the entity word in the entity library is generated by: extracting an entity word in an encyclopedia knowledge library, and adding the extracted entity word to the entity library; and/or acquiring multimedia data of multiple types, extracting, under each of multiple entity dimensions, an entity word of the multimedia data of each type, and adding the extracted entity word to the entity library.

In an embodiment, the selecting, from candidate keywords corresponding to the description content, a target keyword matching an entity word in an entity library includes: selecting, if multiple matching keywords matching the entity word in the entity library are determined from the candidate keywords corresponding to the description content, at least one target keyword from the multiple matching keywords based on user historical behavior data corresponding to the multiple matching keywords and/or multimedia content information corresponding to the multiple matching keywords.

In an embodiment, the adding a search identifier to the target keyword in the description content includes: presetting the target keyword to be emphasized; and/or adding a search indicator at a preset position corresponding to the target keyword, where the search indicator indicates that a search is to be initiated based on the target keyword.

In an embodiment, after the adding a search identifier to the target keyword in the description content, the method further includes: pushing the multimedia content added with the search identifier to a user terminal; and receiving a search request sent by the user terminal based on the target keyword corresponding to the search identifier, and pushing the search result aggregation information corresponding to the target keyword to the user terminal.

In an embodiment, the generating, based on a search result under at least one content type corresponding to the target keyword, search result aggregation information corresponding to the target keyword includes: generating an aggregated result under all content types corresponding to the target keyword based on the search result under the at least one content type corresponding to the target keyword; and generating the search result aggregation information corresponding to the target keyword based on the aggregated result under the all content types corresponding to the target keyword.

In a second aspect, a method for triggering a search is further provided according to an embodiment of the present disclosure. The method includes: acquiring multimedia content and displaying the acquired multimedia content, where description content of the multimedia content comprises at least one target keyword added with a search identifier; initiating a search request based on a target keyword corresponding to the search identifier in response to the search identifier being triggered, and receiving search result aggregation information fed back from a server; and displaying the search result aggregation information on a search result page that is currently jumped to.

In an embodiment, the displaying the search result aggregation information on a search result page that is currently jumped to includes: displaying a search result of the target keyword in an aggregation card on the search result page that is currently jumped to, where the search result includes an aggregated result under at least one content type corresponding to the target keyword.

In a third aspect, an apparatus for triggering a search is further provided according to an embodiment of the present disclosure. The apparatus includes: an acquisition module, a selection module, a generation module and a search module. The acquisition module is configured to acquire description content in multimedia content. The selection module is configured to select, from candidate keywords corresponding to the description content, a target keyword matching an entity word in an entity library. The generation module is configured to generate, based on a search result under at least one content type corresponding to the target keyword, search result aggregation information corresponding to the target keyword. The search module is configured to add a search identifier to the target keyword in the description content. The search identifier points to the search result aggregation information corresponding to the target keyword.

In a fourth aspect, an apparatus for triggering a search is further provided according to an embodiment of the present disclosure. The apparatus includes: an acquisition module, a search module, and a display module. The acquisition module is configured to acquire multimedia content and display the acquired multimedia content. Description content of the multimedia content comprises at least one target keyword added with a search identifier. The generation module is configured to configured to initiate a search request based on a target keyword corresponding to the search identifier in response to the search identifier being triggered, and receive search result aggregation information fed back from a server. The search module is configured to display the search result aggregation information on a search result page that is currently jumped to.

In a fifth aspect, an electronic device is further provided according to an embodiment of the present disclosure. The electronic device includes a processor, a memory and a bus. The memory stores machine-readable instructions executable by the processor. The processor is configured to, when the electronic device is running, communicate with the memory via the bus, and execute the machine-readable instructions to perform the method for triggering a search in the first and second aspects as well as the above embodiments.

In a sixth aspect, a computer-readable storage medium is further provided according to an embodiment of the present disclosure. The computer-readable storage medium storing a computer program that, when being executed by a processor, implements the method for triggering a search in the first and second aspects as well as the above embodiments.

With the above solution for triggering a search, after acquiring the description content in the multimedia content, the server selects the target keyword matching the entity word in the entity library from the candidate keywords corresponding to the description content, generates, based on a search result under at least one content type corresponding to the target keyword, search result aggregation information corresponding to the target keyword, and adds a search identifier to the target keyword in the description content. In this way, after the search identifier in the multimedia content displayed on a user terminal is triggered, a search result page corresponding to the target keyword is jumped to, so as to browse the related search result aggregation information. That is, in the above solution, the target keyword is determined based on the description content of the multimedia content, and the search identifier that leads to the search result page displaying the search result aggregation information is added to the target keyword. In this way, in response to the search identifier being triggered, the corresponding search result page can be directly jumped to based on the added search identifier, so as to browse the related search result aggregation information, without manual input from the user. The process is simple, and the time spent on searching is reduced, thereby improving search experience of users.

Preferred embodiments are exemplified and described in detail below with reference to the drawings, so that the above objects, features and advantages of the present disclosure are clear and comprehensible.

### BRIEF DESCRIPTION OF THE DRAWINGS

In order to illustrate the technical solutions of the embodiments of the present disclosure more clearly, the drawings in the embodiments are briefly introduced below. The drawings, which are incorporated into and constitute a part of this specification, illustrate the embodiments consistent with the present disclosure, and serve to explain the technical solutions of the present disclosure together with the specification. It should be understood that the following drawings illustrate only certain embodiments of the present disclosure and are therefore not to be considered limiting of scope. Those skilled in the art may also obtain other related drawings based on these drawings without any creative effort.

FIG. 1 is a flowchart illustrating a method for triggering a search according to a first embodiment of the present disclosure;

FIG. 2 is a flowchart illustrating the method for triggering a search according to the first embodiment of the present disclosure in a different manner;

FIGS. 3(a) to 3(b) are schematic diagram illustrating applications of the method for triggering a search according to the first embodiment of the present disclosure;

FIG. 4 is a schematic diagram illustrating an apparatus for triggering a search provided according to a second embodiment of the present disclosure;

FIG. 5 is a schematic diagram illustrating the apparatus for triggering a search provided according to the second embodiment of the present disclosure in a different manner;

FIG. 6 is a schematic diagram illustrating an electronic device according to a third embodiment of the present disclosure; and

FIG. 7 is a schematic diagram illustrating the electronic device according to the third embodiment of the present disclosure in a different manner.

### DETAILED DESCRIPTION

The technical solutions in the embodiments of the present disclosure are clearly and completely described below with reference to the drawings in the embodiments of the present disclosure, so that the objects, technical solutions and advantages of the embodiments of the present disclosure are clear. It is apparent that the described embodiments are only some rather than all embodiments of the present disclosure. The components in the disclosed embodiments described and illustrated in the drawings herein may be generally arranged and designed in a variety of configurations. Therefore, the following detailed description of the embodiments of the present disclosure provided in the drawings merely shows representative of selected embodiments of the present disclosure rather than being intended to limit the scope of the present disclosure as claimed. Based on the embodiments of the present disclosure, all other embodiments obtained by those skilled in the art without creative work fall within the protection scope of the present disclosure.

It is found from research that, a user has to manually input a keyword to initiate a search request for unknown information in the related art, which is time-consuming, resulting in poor search experience.

Based on the above research, at least one solution for triggering a search is provided according to the present disclosure. A search is automatically initiated by triggering a target keyword with a search identifier without manual input, thereby reducing the time spent on searching and improving search experience of users.

The disadvantages of the existing solution are obtained from practice and in-depth research. Therefore, the process of finding the above problems and solutions to the problems hereinafter should be contributions to the present disclosure.

It should be noted that similar numerals and letters refer to similar items in the drawings. Therefore, an item that is already defined in one Figure is unnecessarily defined and explained in subsequent Figures.

In order to facilitate understanding of embodiments, a method for triggering a search according to an embodiment of the present disclosure is first introduced in detail. The method for triggering a search according to the embodiment of the present disclosure is generally performed by an electronic device capable of computing. The electronic device includes, for example, a server or other processing apparatus. In some possible implementations, the method for triggering a search may be implemented by a processor calling computer-readable instructions stored in a memory.

The method for triggering a search according to an embodiment of the present disclosure, for example, performed by a server, is described below.

### First Embodiment

FIG. 1 is a flowchart illustrating a method for triggering a search according to the first embodiment of the present disclosure. The method includes the following steps S101 to S103.

In S101, description content in multimedia content is acquired.

In S102, a target keyword matching an entity word in an entity library is selected from candidate keywords corresponding to the description content.

In S103, search result aggregation information corresponding to the target keyword is generated based on a search result under at least one content type corresponding to the target keyword.

In S104, a search identifier is added to the target keyword in the description content. The search identifier points to the search result aggregation information corresponding to the target keyword.

Here, in order to facilitate understanding of the method for triggering a search according to the embodiment of the present disclosure, an application scenario of the method for triggering a search is briefly introduced first.

Relevant description content is presented on a display page of the multimedia content. The description content may be added actively by a user when publishing the multimedia content, such as a video title, and a video introduction. Alternatively, the description content may be automatically generated by the server based on the multimedia content. For example, the server automatically extracts the description content based on picture information, audio content and the like corresponding to the multimedia content.

Here, the target keyword is selected from the candidate keywords corresponding to the description content of the multimedia content. Then, the search identifier is added to the target keyword. The multimedia content added with the search identifier is pushed to a user terminal. The currently presented page is switched, in response to the target keyword on the user terminal being triggered and based on the added search identifier, to a page presenting the search result aggregation information which the target keyword points to. The search identifier may include the target keyword that is emphasized, and a search indicator added at a preset position corresponding to the target keyword. The search indicator indicates that a search is to be initiated based on the target keyword. In addition, a search jump link may be added to the target keyword in order to automatically trigger the switch between a currently presented page to another. It can be seen from the above that, a search can be initiated by one-click triggering when the user is interested in the target keyword. It is unnecessary for the user to enter a keyword for searching, thereby reducing time spent on searching and improving search experience.

Optionally, the search result aggregation information may be determined based on a search result under at least one content type corresponding to the target keyword. The content type here may include a small video, a picture with texts, a special topic, a picture, a knowledge map and the like. In this way, the search result aggregation information generated based on search results under various content types is displayed on the user terminal after the user triggers the search identifier.

It can be seen that with the method for triggering a search according to the embodiment of the present disclosure, the search result aggregation information can be presented, so that comprehensive and rich information can be displayed within a certain display range. In this way, users can quickly browse results they are interested in, and can further obtain more detailed information by triggering relevant aggregated results.

The multimedia content according to the embodiments of the present disclosure includes pictures, videos, or other forms of multimedia content. In view of the wide application of video search, the embodiments of the present disclosure are described below with the video as the multimedia content.

If a candidate keyword corresponding to the description content exists in the entity library, it is indicated that the candidate keyword is a target keyword hit by the entity library. The entity words in the entity library may include keywords of various attributes in different fields, such as names of films and names of actors in the field of film and television, various professional terms in the field of science and technology, popular Internet terms in the field of Internet, as well as names of literary works and names of authors in the field of literature.

Entity words in the encyclopedia knowledge library may be extracted and added to the entity library, and therefore the entity library is established. In addition, multimedia data of various types may be acquired, entity words of the multimedia data of each type under each entity dimension are extracted, and the extracted entity words are added to the entity library. For example, various types of videos (such as movies, TV series, variety shows, and short videos), and live videos are acquired. Keywords of these multimedia data under multiple entity dimensions such as the movie name, the TV series name, the variety show name, the star name, and the commodity are extracted. The extracted keywords serve as entity words in the entity library.

In addition, the entity words in the entity library may be updated periodically. The entity words in the entity library may be updated based on updated multimedia data in the current cycle. The multimedia data updated in the current cycle is multimedia data that is searchable by the user on a platform in the current cycle. In this way, if a periodically updated entity word is presented in the relevant multimedia content and has a corresponding search identifier, a video or a page presenting a video associated with the entity word is jumped to after the user initiates a search for the entity word. Therefore, different multimedia contents currently displayed can be interlinked.

In the embodiments of the present disclosure, the candidate keywords corresponding to the description content may be determined based on word segmentation, and then the target keyword may be selected, in the above way for determining the target keyword, from the candidate keywords obtained by the segmentation.

In practice, the word segmentation may be implemented by using a rule-based word segmentation method. For example, the description content is divided by dictionary matching based on an artificially created dictionary. Alternatively, the word segmentation is implemented by using a statistical-based word segmentation method. For example, a sentence is divided into words based on a pre-established statistical language model, and then probability calculation is performed on the division result, and a word segmentation method with a highest probability is determined as a word segmentation result. In addition to the above, other word segmentation methods may also be used in the embodiments of the present disclosure. The word segmentation method is not limited herein.

In the embodiments of the present disclosure, the number of candidate keywords hit by the entity library may be one or multiple in a case of multiple candidate keywords determined. In a case of multiple candidate keywords hit by the entity library, all the hit candidate keywords may be directly used as target keywords. Alternatively, the candidate keywords hit by the entity library are further filtered, so as to select a target keyword with more search intent.

Multiple matching keywords matching entity words in the entity library are first determined from candidate keywords corresponding to the description content. Here, for each of the candidate keywords, the candidate keyword is matched with entity words in the entity library. If the matching is successful, the candidate keyword is determined as a matching keyword.

In the embodiments of the present disclosure, at least one target keyword may be selected from the multiple matching keywords according to the user historical behavior data, multimedia content information and the like corresponding to the multiple matching keywords. That is, the hit candidate keywords are further filtered to determine a final selected target keyword.

The user historical behavior data related to matching keywords may be historical behavior data of users for matching keywords, and/or historical behavior data of articles, videos, live videos and the like that contain the matching keywords. The historical behavior data includes the number of searches, the number of clicks, the number of views, the number of comments, the number of forwards, and the like. In this way, a matching keyword that is currently most popular and most concerned by users may be selected as the target keyword. The multimedia content information about the matching keyword may be related information such as multimedia content type (such as a long video, a live video and the like) and multimedia content quality (such as whether it is risky media content) obtained after searching for the multimedia content for the matching keyword. In this way, a matching keyword with high quality corresponding to the multimedia content that is searched for is selected as the target keyword.

In the embodiments of the present disclosure, the target keyword may be emphasized in order to facilitate initiating a search based on the target keyword. In this way, the user, when viewing the current multimedia content, can quickly find a target keyword to be jumped to on the display page, thereby further reducing the time spent on searching.

The target keyword is emphasized so as to be distinguished from other candidate keywords in the description content. For example, the target keyword may be highlighted, colored, bolded, dropped and so on, which is not limited herein.

In addition, in the embodiments of the present disclosure, a search indicator (for example, [symbol] ) may be added to the target keyword, to remind the user that the target keyword is triggerable. After the target keyword is triggered, a search result page is automatically jumped to, so as to display the search result aggregation information.

For a better search reminder, the search indicator is presented at an upper right corner of the target keyword according to an embodiment of the present disclosure. Alternatively, the relative position between the search indicator and the target keyword is set depending on the text arrangement adopted for the description content, which is not described in detail herein.

With the method for triggering a search according to the embodiments of the present disclosure, after the target keyword is determined, the multimedia content added with the search identifier is pushed to the user terminal. After the search identifier displayed on the user terminal is triggered by the user, a search request for the target keyword corresponding to the search identifier is sent to the server. The server recalls search result aggregation information corresponding to the target keyword based on the search request, and pushes the search result aggregation information to the user terminal for display. The search identifier may be triggered by single click, double click and so on, which is not limited herein.

The search result aggregation information may be determined based on aggregated results under various content types. The aggregated result under each content type may be aggregated based on search results under the content type. The content types may include small videos, live videos, long videos, news, topic discussions, pictures, encyclopedic knowledge and so on.

For example, multimedia contents under multiple content types corresponding to a target keyword are recalled, and the recalled multimedia contents are aggregated from different dimensions. Each dimension covers at least one of the content types. For example, an aggregated result under the video dimension may be obtained, including video aggregation information under content types such as small videos, live videos, and long videos. Further, an aggregated result under the encyclopedia dimension is obtained, including encyclopedic knowledge aggregation information corresponding to the target keyword. Further, an aggregated result under the hot search dimension is obtained. Under the hot search dimension, popular search results under content types such as news, topic discussions, and various videos are aggregated to obtain an event hot discussion aggregated result (in which hot topics are displayed, and each hot topic corresponds to the aggregated information under various content types such as videos, pictures, news and so on) and an entity event aggregated result (in which detailed introduction is displayed). Further, an aggregated result under a character dimension is obtained. Under the character dimension, related image content and the like are displayed.

In practice, various content types are preset according to embodiments of the present disclosure. Then, search results corresponding to the target keyword under the various content types are obtained and aggregated, so as to determine the search result aggregation information based on the aggregated result. Compared with scattered display of search results, the aggregated display of search results is convenient for users to quickly browse, so as to quickly position the search results.

Next, the method for triggering a search according to an embodiment of the present disclosure, for example, performed by a user terminal, is described.

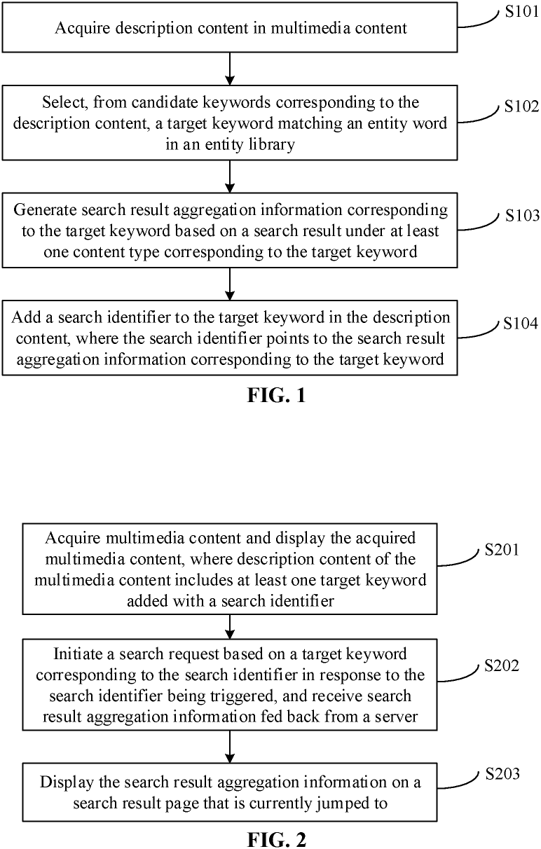

FIG. 2 is a flowchart illustrating the method for triggering a search according to the first embodiment of the present disclosure in a different manner. The method shown in FIG. 2 includes the following steps S201 to S203.

In S201, multimedia content is acquired and displayed. Description content of the multimedia content includes at least one target keyword added with a search identifier.

In S202, in response to the search identifier being triggered, a search request based on the target keyword corresponding to the search identifier is initiated, and search result aggregation information fed back from a server is received.

In S203, the search result aggregation information is displayed on a search result page that is jumped to.

Here, the user terminal is configured to acquire multimedia content (pushed by the server or pre-stored by in the user terminal) and display the acquired multimedia content. Since the target keyword in the multimedia content is added with a search identifier, a search request for the target keyword is initiated to the server in response to the search identifier being triggered by the user. The server searches for search result aggregation information corresponding to the search request and feeds the found search result aggregation information back to the user terminal. The user terminal may display the corresponding search result aggregation information on the search result page that is currently jumped to.

For the addition of the search identifier and the determination of the search result aggregation information corresponding to the search request, reference is made to the above description of the method for triggering a search performed by the server, and thus details are not repeated here.

In the embodiment of the present disclosure, the user terminal may display the search result aggregation information in an aggregation card. It should be noted that, depending on search requirements of the user terminal for search results of different content types, one content type may occupy one or more display position (hereinafter booth) in practice. For example, for the content type of small videos, each small video may occupy one booth.

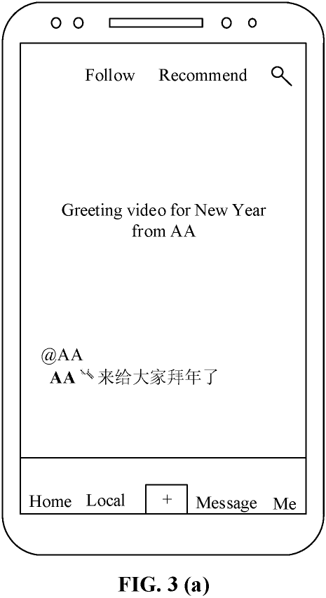

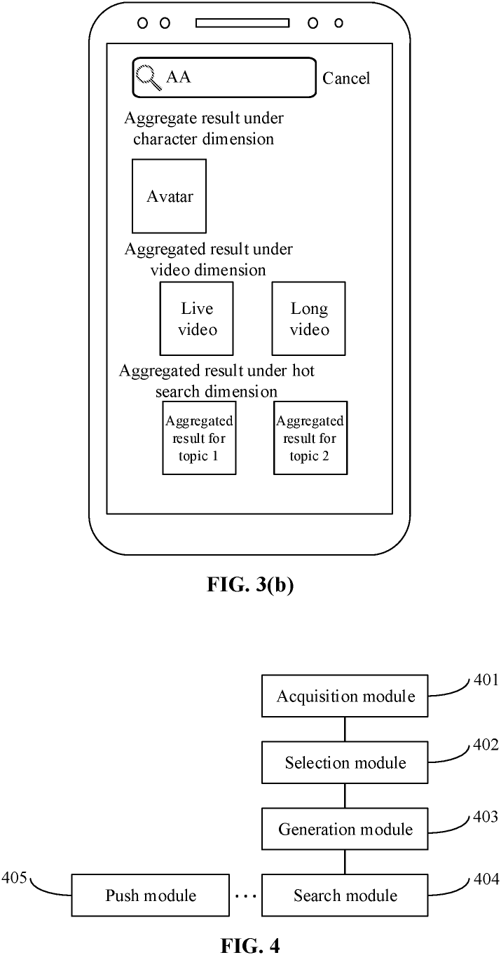

Here, the user terminal may initiate a search for the displayed target keyword with the search identifier. The method for triggering a search according to the embodiment of the present disclosure is described below with reference FIGS. 3(a) to 3(b), which are schematic diagram illustrating display effects on an interface of the user terminal.

As shown in FIG. 3(a), multimedia content (that is, greeting video for New Year from AA) is presented on the interface of the user terminal. In this way, after determining that the description content in the multimedia content is the description text “AA [symbol] [symbol] ”, the server determines that candidate keywords corresponding to the description content may be “AA”, “ [symbol] ”, “ [symbol] ”, and “ [symbol] ”. In this case, if it is determined that the target keyword hit by the entity library is the name AA, a search identifier is added to the target keyword AA. The target keyword added with the search identifier may be displayed in bold (while other candidate keywords are not displayed in bold), as shown in FIG. 3(a). In addition, a search indicator [symbol] may be added to the target keyword to remind the user that the corresponding search is to be implemented by triggering the target keyword AA.

After the user triggers the search on AA, the interface jumps to a search result page based on the search identifier added to AA, as shown in FIG. 3(b).

The search result aggregation information corresponding to AA is displayed on the search result page shown in FIG. 3(b). The search result aggregation information may correspond to the aggregated results of AA in different dimensions. Each dimension may include at least one content type. For example, avatars of a relevant character in the task dimension (corresponding to the content type of pictures) may be displayed. Further, one or more pieces of popular video information about the character in the video dimension (for example, corresponding to content types such as live videos, small videos, and long videos) are displayed. Further, one or more pieces of hot search result information about the character in the hot search dimension (for example, corresponding to the content type such as hot topics) are displayed. Besides, other information related to the character may also be displayed, which is not limited in this embodiment of the present disclosure.

It should be noted that, the relevant search result may be displayed on the aggregation card in practice. For example, a video about the popular search information may be directly displayed in order to present the popular search information. The live video and the long video shown in FIG. 3(b) respectively correspond to two booths under the content type of the video corresponding to the popular search information. In the embodiment of the present disclosure, the video displayed on the booth may be played automatically or by triggered by the user. After one of the aggregated results of the hot topic 1 and the hot topic 2 shown in FIG. 3(b) is triggered, the multimedia content corresponding to the triggered topic is to be viewed.

The aggregated result of the topic 1 serves as an example. Information in the aggregated result of the topic 1 is generated based on topic information of each piece of multimedia content corresponding to the topic 1. In this way, after browsing the information in the aggregated result of the topic 1, the user confirms to be interested in the topic 1, and further browses a series of multimedia contents corresponding to the topic 1 by triggering the aggregated result of the topic 1.

Those skilled in the art should understand that, in the above method embodiments, the order in which the steps are written does not indicate a strict order in which the steps are performed and therefore constitutes no limitation on implementations. The order in which the steps are performed depends on functions and possible internal logic.

Based on the same inventive concept, an apparatus for triggering a search corresponding to the method for triggering a search is further provided according to an embodiment of the present disclosure. Since the principle of solving the problem by the apparatus in the embodiment of the present disclosure is similar to that solved by the method, apparatus embodiments may refer to the method embodiments, and thus the apparatus is not described in detail herein.

### Second Embodiment

Referring to FIG. 4, which is a schematic diagram illustrating an apparatus for triggering a search provided according to the second embodiment of the present disclosure. The apparatus includes an acquisition module 401, a selection module 402, a generation module 403 and a search module 404.

The acquisition module 401 is configured to acquire description content in multimedia content.

The selection module 402 is configured to select, from candidate keywords corresponding to the description content, a target keyword matching an entity word in an entity library.

The generation module 403 is configured to generate search result aggregation information corresponding to the target keyword based on a search result under at least one content type corresponding to the target keyword.

The search module 404 is configured to add a search identifier to the target keyword in the description content. The search identifier points to the search result aggregation information corresponding to the target keyword.

In an embodiment, in order to generate entity words in the entity library, the selection module 402 is configured to: extract an entity word in an encyclopedia knowledge library, and add the entity word to the entity library; and/or acquire multimedia data of various types, extract entity words of the multimedia data of each type under each entity dimension of multiple entity dimensions, and add the extracted entity words to the entity library.

In an embodiment, in order to select the target keyword matching the entity word in the entity library, the selection module 402 is configured to select, if multiple matching keywords matching the entity word in the entity library are determined from the candidate keywords corresponding to the description content, at least one target keyword from the multiple matching keywords based on user historical behavior data corresponding to the multiple matching keywords and/or multimedia content information corresponding to the multiple matching keywords.

In an embodiment, in order to add the search identifier to the target keyword in the description content, the search module 404 is configured to: preset the target keyword to be emphasized; and/or add a search indicator at a preset position corresponding to the target keyword. The search indicator indicates that a search is to be initiated based on the target keyword.

In an embodiment, the apparatus further includes a push module 405. The push module 405 is configured to, after the search identifier is added to the target keyword in the description content, push the multimedia content added with the search identifier to a user terminal, receive a search request sent from the user terminal based on the target keyword corresponding to the search identifier, and push the search result aggregation information corresponding to the target keyword to the user terminal.

In an embodiment, in order to generate the search result aggregation information corresponding to the target keyword, the generation module 403 is configured to: generate an aggregated result under all content types corresponding to the target keyword based on a search result under at least one content type corresponding to the target keyword; and generate the search result aggregation information corresponding to the target keyword based on the aggregated result under the all content types corresponding to the target keyword.

With the above apparatus, in response to the search identifier being triggered, the corresponding search result page can be directly jumped to based on the search identifier, without manual input from the user. The process is simple, and the time spent on searching is reduced, thereby improving search experience of users.

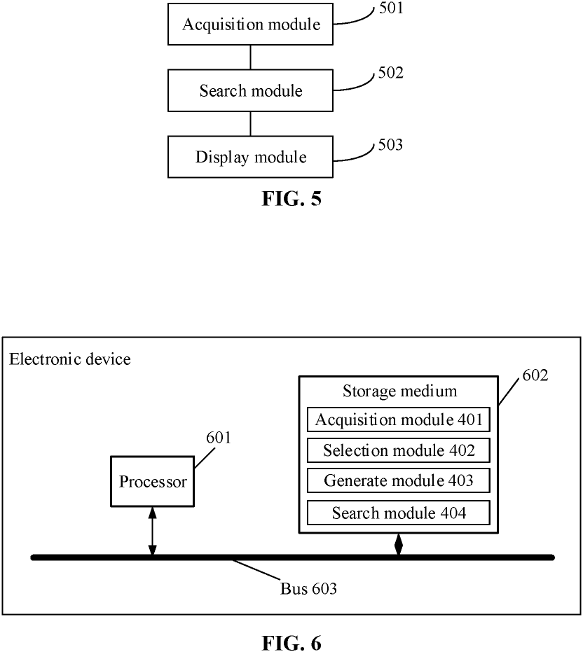

FIG. 5 is a schematic diagram illustrating the apparatus for triggering a search provided according to the second embodiment of the present disclosure in a different manner. The apparatus includes an acquisition module 501, a search module 502, and a display module 503.

The acquisition module 501 is configured to acquire multimedia content and display the acquired multimedia content. Description content of the multimedia content includes at least one target keyword added with a search identifier.

The search module 502 is configured to initiate a search request based on a target keyword corresponding to the search identifier in response to the search identifier being triggered, and receive search result aggregation information fed back from a server.

The display module 503 is configured to display the search result aggregation information on a search result page that is currently jumped to.

In an embodiment, in order to display the search result, the display module 503 is configured to display a search result of the target keyword in an aggregation card on the search result page that is currently jumped to. The search result includes an aggregated result under at least one content type corresponding to the target keyword.

### Third Embodiment

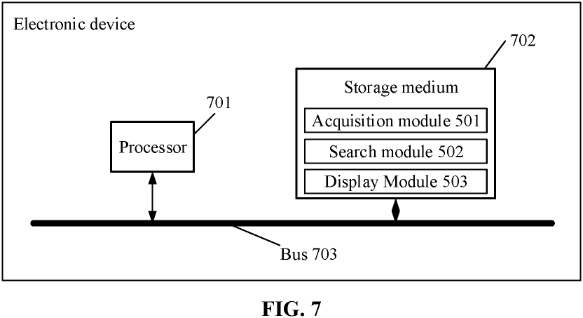

An electronic device is further provided according to an embodiment of the present disclosure. The electronic device may be a server or a user terminal. FIG. 6 is a schematic diagram illustrating an electronic device that is a server according to an embodiment of the present disclosure. The electronic device includes a processor 601, a memory 602, and a bus 603. The memory 602 stores machine-readable instructions executable by the processor 601 (that is, instructions executed by the acquisition module 401, the selection module 402, the generation module 403 and the search module 404 in the apparatus for triggering a search as shown in FIG. 4). When the electronic device is running, the processor 601 communicates with the memory 602 through the bus 603 and executes the machine-readable instructions so as to: acquire description content in multimedia content; select a target keyword matching an entity word in an entity library from candidate keywords corresponding to the description content; generate search result aggregation information corresponding to the target keyword based on a search result under at least one content type corresponding to the target keyword; and add a search identifier to the target keyword in the description content. The search identifier points to the search result aggregation information corresponding to the target keyword.

In an embodiment, in order to generate entity words in the entity library, the processor 601 executes the instructions to: extract an entity word in an encyclopedia knowledge library, and add the entity word to the entity library; and/or acquire multimedia data of various types, extract entity words of the multimedia data of each type under each entity dimension of multiple entity dimensions, and add the extracted entity words to the entity library.

In an embodiment, in order to select the target keyword matching the entity word in the entity library from candidate keywords corresponding to the description content, the processor 601 executes the instructions to: select, if multiple matching keywords matching the entity word in the entity library are determined from the candidate keywords corresponding to the description content, at least one target keyword from the multiple matching keywords based on user historical behavior data corresponding to the multiple matching keywords and/or multimedia content information corresponding to the multiple matching keywords.

In an embodiment, in order to add the search identifier to the target keyword in the description content, the processor 601 executes the instructions to: preset the target keyword to be emphasized; and/or add a search indicator at a preset position corresponding to the target keyword. The search indicator indicates that a search is to be initiated based on the target keyword.

In an embodiment, after the search identifier is added to the target keyword in the description content, the processor 601 executes the instructions to: push the multimedia content added with the search identifier to a user terminal, receive a search request sent from the user terminal based on the target keyword corresponding to the search identifier, and push the search result aggregation information corresponding to the target keyword to the user terminal.

In an embodiment, in order to generate the search result aggregation information corresponding to the target keyword based on the search result under at least one content type corresponding to the target keyword, the processor 601 executes the instructions to: generate an aggregated result under all content types corresponding to the target keyword based on a search result under at least one content type corresponding to the target keyword; and generate the search result aggregation information corresponding to the target keyword based on the aggregated result under the all content types corresponding to the target keyword.

FIG. 7 is a schematic diagram illustrating the electronic device that is a user terminal according to an embodiment of the present disclosure. The electronic device includes a processor 701, a memory 702, and a bus 703. The memory 702 stores machine-readable instructions executable by the processor 701 (instructions executed by the acquisition module 501, the search module 502 and the display module 503 in the apparatus for triggering a search as shown in FIG. 5). When the electronic device is running, the processor 701 communicates with the memory 702 through the bus 703 and executes the machine-readable instructions so as to: acquire multimedia content and display the acquired multimedia content, where description content of the multimedia content includes at least one target keyword added with a search identifier; initiate a search request based on a target keyword corresponding to the search identifier in response to the search identifier being triggered, and receive search result aggregation information fed back from a server; and display the search result aggregation information on a search result page that is currently jumped to.

In an embodiment, in order to display the search result on the search result page that is currently jumped to, the processor 701 executes the instructions to: display the search result of the target keyword in an aggregation card on the search result page that is currently jumped to. The search result includes an aggregated result under at least one content type corresponding to the target keyword.

A computer-readable storage medium is further provided according to an embodiment of the present disclosure. A computer program is stored on the computer-readable storage medium. When the computer program is executed by the processor, the steps of the method in response to the instructions executed by the processor described in the first method embodiment are performed. The storage medium may be a volatile or nonvolatile computer-readable storage medium.

The instructions executable by the processor according to embodiments of the present disclosure are included in a computer program product included in a computer-readable storage medium storing a program code. The instructions included in the program code is for performing the steps of the method in the method embodiment. Reference is made to the above method embodiment for details.

A computer program is further provided according to an embodiment of the present disclosure. The computer program, when executed by a processor, implements the method according to any of the above embodiments. The computer program product may be implemented in hardware, software or a combination thereof. In an optional embodiment, the computer program product is embodied as a computer storage medium. In another optional embodiment, the computer program product is embodied as a software product, such as a software development kit (SDK).

Those skilled in the art should clearly understand that, the system and the device described above may operate with reference to the method, and thus the system and the device are not described in detail herein for convenience and brevity of description. It should be understood that the system, the device and the method according to the embodiments of the present disclosure may be implemented in other manners. The apparatus embodiments described above are merely illustrative. For example, the units are divided based on only logical functions, and may be divided in other manners in practice. In another example, multiple units or components may be combined or may be integrated into another system, or some features may be omitted or not implemented. Further, the shown or discussed coupling or direct coupling or communication connection may be indirect coupling or communication connection via some communication interfaces, devices or units, and may be in electrical, mechanical or other forms.

The units described as separate parts may or may not be physically separate. Components shown as units may or may not be physical units, that is, may be located in one place, or may be distributed over multiple network units. Some or all of the units may be selected as needed achieve the purpose of the solution in the embodiments.

In addition, functional units in the embodiments of the present disclosure may be integrated into one processing unit. Alternatively, the units physically exist individually. Alternatively, two or more units are integrated into one unit.

The functions, if implemented in the form of software functional units and sold or used as stand-alone products, may be stored in a processor-executable non-volatile computer-readable storage medium. Based on such understanding, the technical solutions of the present disclosure in essence or the parts that contribute to the prior art or the parts of the technical solutions may be embodied in the form of software products. The computer software product is stored in a storage medium, and includes several instructions for causing an electronic device (such as a personal computer, a server, or a network device) to perform all or part of the steps of the methods described in the various embodiments of the present disclosure. The storage medium includes various media capable of storing program codes, such as U disk, a removable hard disk, a read only memory (ROM), a random-access memory (RAM), a magnetic disk or an optical disk.

Finally, it should be noted that the above embodiments show only specific implementations of the present disclosure, and are used to illustrate rather than limit the technical solutions of the present disclosure. The protection scope of the present disclosure is not limited thereto. Although the present disclosure has been described in detail with reference to the embodiments, it should be understood by those skilled in the art that any person skilled in the art may modify or easily think of changes to the technical solutions described in the embodiments within the technical scope disclosed in the present disclosure, or perform equivalent replacements for some of the technical features. These modifications, changes or replacements should be included within the protection scope of the present disclosure rather than render the essence of the technical solutions deviating from the spirit and scope of the technical solutions of the embodiments of the present disclosure. Therefore, the protection scope of the present disclosure should be based on the protection scope of the claims.

1. A method for triggering a search, comprising:
acquiring description content in multimedia content;
selecting, from candidate keywords corresponding to the description content, a target keyword matching an entity word in an entity library;
generating, based on a search result under at least one content type corresponding to the target keyword, search result aggregation information corresponding to the target keyword; and
adding a search identifier to the target keyword in the description content, wherein the search identifier points to the search result aggregation information corresponding to the target keyword.

2. The method according to claim 1, wherein the entity word in the entity library is generated by:
extracting an entity word in an encyclopedia knowledge library, and adding the extracted entity word to the entity library; and/or
acquiring multimedia data of a plurality of types, extracting, under each of a plurality of entity dimensions, an entity word of the multimedia data of each type, and adding the extracted entity word to the entity library.

3. The method according to claim 1, wherein the selecting, from candidate keywords corresponding to the description content, a target keyword matching an entity word in an entity library comprises:
selecting, if a plurality of matching keywords matching the entity word in the entity library are determined from the candidate keywords corresponding to the description content, at least one target keyword from the multiple matching keywords based on user historical behavior data corresponding to the plurality of matching keywords and/or multimedia content information corresponding to the plurality of matching keywords.

4. The method according to claim 1, wherein the adding a search identifier to the target keyword in the description content comprises:
presetting the target keyword to be emphasized; and/or
adding a search indicator at a preset position corresponding to the target keyword, wherein the search indicator indicates that a search is to be initiated based on the target keyword.

5. The method according to claim 1, wherein after the adding a search identifier to the target keyword in the description content, the method further comprises:
pushing the multimedia content added with the search identifier to a user terminal; and
receiving a search request sent by the user terminal based on the target keyword corresponding to the search identifier, and pushing the search result aggregation information corresponding to the target keyword to the user terminal.

6. The method according to claim 1, wherein the generating, based on a search result under at least one content type corresponding to the target keyword, search result aggregation information corresponding to the target keyword comprises:
generating an aggregated result under all content types corresponding to the target keyword based on the search result under the at least one content type corresponding to the target keyword; and
generating the search result aggregation information corresponding to the target keyword based on the aggregated result under the all content types corresponding to the target keyword.

7. A method of triggering a search, comprising:
acquiring multimedia content and displaying the acquired multimedia content, wherein description content of the multimedia content comprises at least one target keyword added with a search identifier;
initiating a search request based on a target keyword corresponding to the search identifier in response to the search identifier being triggered, and receiving search result aggregation information fed back from a server; and
displaying the search result aggregation information on a search result page that is currently jumped to.

8. The method according to claim 7, wherein the displaying the search result aggregation information on a search result page that is currently jumped to comprises:
displaying a search result of the target keyword in an aggregation card on the search result page that is currently jumped to, wherein the search result comprises an aggregated result under at least one content type corresponding to the target keyword.

9. An apparatus for triggering a search, comprising:
at least one processor; and
at least one memory communicatively coupled to the at least one processor and storing instructions that upon execution by the at least one processor cause the apparatus to perform the method for triggering a search according to claim 1 .

10. An apparatus for triggering a search, comprising:
at least one processor; and
at least one memory communicatively coupled to the at least one processor and storing instructions that upon execution by the at least one processor cause the apparatus to:
acquire multimedia content and display the acquired multimedia content, wherein description content of the multimedia content comprises at least one target keyword added with a search identifier;
initiate a search request based on a target keyword corresponding to the search identifier in response to the search identifier being triggered, and receive search result aggregation information fed back from a server; and
display the search result aggregation information on a search result page that is currently jumped to.

11. (canceled)

12. A computer-readable non-transitory storage medium storing a computer program that, when being executed by a processor, implements the method for triggering a search according to claim 1.

13. The method according to claim 2, wherein the selecting, from candidate keywords corresponding to the description content, a target keyword matching an entity word in an entity library comprises:
selecting, if a plurality of matching keywords matching the entity word in the entity library are determined from the candidate keywords corresponding to the description content, at least one target keyword from the multiple matching keywords based on user historical behavior data corresponding to the plurality of matching keywords and/or multimedia content information corresponding to the plurality of matching keywords.

14. The apparatus of claim 9, wherein the entity word in the entity library is generated by:
extracting an entity word in an encyclopedia knowledge library, and adding the extracted entity word to the entity library; and/or
acquiring multimedia data of a plurality of types, extracting, under each of a plurality of entity dimensions, an entity word of the multimedia data of each type, and adding the extracted entity word to the entity library.

15. The apparatus of claim 9, the at least one memory further storing instructions that upon execution by the at least one processor cause the apparatus to:
select, if a plurality of matching keywords matching the entity word in the entity library are determined from the candidate keywords corresponding to the description content, at least one target keyword from the multiple matching keywords based on user historical behavior data corresponding to the plurality of matching keywords and/or multimedia content information corresponding to the plurality of matching keywords.

16. The apparatus of claim 9, the at least one memory further storing instructions that upon execution by the at least one processor cause the apparatus to:
preset the target keyword to be emphasized; and/or
add a search indicator at a preset position corresponding to the target keyword, wherein the search indicator indicates that a search is to be initiated based on the target keyword.

17. The apparatus of claim 9, the at least one memory further storing instructions that upon execution by the at least one processor cause the apparatus to:
push the multimedia content added with the search identifier to a user terminal; and
receive a search request sent by the user terminal based on the target keyword corresponding to the search identifier, and pushing the search result aggregation information corresponding to the target keyword to the user terminal.

18. The apparatus of claim 9, the at least one memory further storing instructions that upon execution by the at least one processor cause the apparatus to:
generate an aggregated result under all content types corresponding to the target keyword based on the search result under the at least one content type corresponding to the target keyword; and
generate the search result aggregation information corresponding to the target keyword based on the aggregated result under the all content types corresponding to the target keyword.

19. The apparatus of claim 14, the at least one memory further storing instructions that upon execution by the at least one processor cause the apparatus to:
select, if a plurality of matching keywords matching the entity word in the entity library are determined from the candidate keywords corresponding to the description content, at least one target keyword from the multiple matching keywords based on user historical behavior data corresponding to the plurality of matching keywords and/or multimedia content information corresponding to the plurality of matching keywords.

20. The apparatus of claim 10, the at least one memory further storing instructions that upon execution by the at least one processor cause the apparatus to:
display a search result of the target keyword in an aggregation card on the search result page that is currently jumped to, wherein the search result comprises an aggregated result under at least one content type corresponding to the target keyword.
